(19) United States
(12) Patent Application Publication
(10) Pub. No.: US 2015/0107246 A1
(43) Pub. Date: Apr. 23, 2015

(54) SYSTEM AND METHOD FOR HEAT STORAGE IN SOLAR THERMAL POWER PLANTS

(71) Applicant: KRISHNA KUMAR BINDINGNAVALE RANGA, BANGALORE (IN)

(72) Inventor: KRISHNA KUMAR BINDINGNAVALE RANGA, BANGALORE (IN)

(21) Appl. No.: 14/513,483

(22) Filed: Oct. 14, 2014

(30) Foreign Application Priority Data
Oct. 18, 2013 (IN) 1723/CHE/2013

(51) Int. Cl. F24J 2/34; F03G 6/06

(52) U.S. Cl. CPC F24J 2/34; F03G 6/067; F03G 2006/008
USPC 60/641.15; 126/619; 126/714

(57) ABSTRACT

The embodiments herein provide an improved method for storing thermal energy from the sun in a CSP plant. The heat storage system used for storing the thermal energy has a spherical shell filled with a salt, and several insulated storage towers. The method for storing thermal energy comprises adopting a plurality of spherical shells and filling the spherical shells with the salt. The salt is a mixture of sodium nitrate and potassium nitrate. The spherical shells filled with the salt are packed inside the insulated storage tower. During the day time, a HTF is passed through the tower to melt the salt and store thermal energy. After sunset, the HTF is passed through the storage tower to absorb heat from the salt in the spherical shells. The HTF is then passed through the boiler for producing steam and driving, the turbine.

### CROSS REFERENCE TO RELATED APPLICATIONS

This patent application claims the priority of the Indian Provisional Patent Application No. 1723/CHE/203 filed on Apr. 18, 2013, and postdated to Oct. 18, 2013 with the title “A Method for Heat Storage in Solar Thermal Power Plants”, and the content of which is incorporated in entirety by reference herein,

### BACKGROUND

1. Technical Field

The embodiments herein generally relate to the field of electrical power generation through solar thermal power and particularly relates to a method and a system for storing the solar thermal energy in a solar thermal power plant. The embodiments herein more particularly relates to a system and method for improving the solar thermal energy storage capacity by employing a molten salt in a concentrated solar thermal power plant.

2. Description of the Related Art

The solar thermal power plants harness the radiant energy of the sun to produce electricity. A typical Concentrated Solar Thermal Power (CSP) plant consists of a large number of mirrors which concentrate the radiant energy of the sun onto the tubes carrying a heat transfer fluid (HTF). This HTF transfers the absorbed heat to water through a heat exchanger. The water is converted into steam and is used to drive a steam turbine-generator set for generating electric energy. The CSP power plants however suffer from the same problem that all the solar thermal based systems have to deal with; the changing position of the sun. Because of the changing position of sun, the radiant energy of the sun is never constant throughout the day and the power is produced only till the sun is out. To producing power continuously even after the sun is set, technologies have been developed to store the thermal energy of the sun. There are several methods to store the thermal energy such as water storage, packed bed storage systems, storage walls, thermocline systems and molten salt based systems.

According to the existing methods, the most popular way of storing the thermal energy is the usage of molten salt to absorb the heat of the sun rays. This process involves heating a salt material till the melting temperature and then storing the molten salts in the tanks. A separate tank is used for storing the hot and cold salts. The hot molten salt is then used to produce steam in a steam generator, which is then used to drive a steam turbine-generator set for generating a power. The molten salt is directly pumped to the heat exchangers for generating the steam. Though, this process enables the production of energy after the sun is set, the molten salt requires two tanks for storage, one for hot and another for cold salt. Also, there are chances of the pumped molten salt being frozen during the passage of the salt to the heat exchangers or in any other part and thereby blocking the flow and the power plant operation.

Hence, there is a need for an improved method and a system for storing the thermal energy using the molten salt in the solar thermal power plant. Also, there is a need for a method and a system to improve the thermal storage capacity of molten salt in solar thermal power plants. Further there is a need for method and a system for handling the molten salts.

### OBJECTIVES OF THE EMBODIMENTS

The primary objective of the embodiments herein is to provide a thermal storage system for storing the thermal energy of the sun and a method for using the stored energy after the sunset.

Another objective of the embodiments herein is to provide a method to simplify the thermal energy storage system.

Yet another objective of the embodiments herein is to provide a method for improving the thermal energy storage by means of a molten salt tower packing.

Yet another objective of the embodiments herein is to provide a method to prevent a freezing of the molten salt during circulation.

These and other objects and advantages of the embodiments herein will become readily apparent from the following detailed description taken in conjunction with the accompanying drawings.

### SUMMARY

The embodiments herein provide an improved method and system for storing thermal energy from the sun in a concentrated solar thermal power plant. The heat storage system for storing the thermal energy of the sun comprises a plurality of insulated storage towers configured for storing a thermal energy obtained from sun and a plurality of spherical shells filled with a salt substance. The solar towers hold the plurality of spherical shells. The system further comprises a fluid circulating tube for carrying a Heat Transfer Fluid (HTF). The HTF is configured to carry heat generated from a solar energy between the plurality of solar towers to a heat exchanger. The salt substance is used to capture heat from the HTF.

According to one embodiment herein, the salt substance is eutectic mixture of salts with appropriate melting point.

According to one embodiment herein, the solar towers are insulated, to avoid a dissipation of the stored thermal energy from the spherical shells to the surroundings.

According to one embodiment herein, a plurality of voids is formed between the plurality of spherical shells. The voids allow the flow of the HTF through the tower to an outlet of the thermal power plant.

According to one embodiment herein, the spherical shells comprise a plurality of fins, where the fins are protrusions formed on the outer surface of the spherical shells. The plurality of fins assists in an effective heat transfer between the HTF and the salt substance inside the spherical shells.

According to one embodiment herein, the concentrated solar thermal power plant comprises a solar field for collecting and concentrating a plurality of sun rays. The concentrated sun rays are directed to the solar towers by a plurality of mirrors,

According to one embodiment herein, the fluid circulating tube is placed at the focusing point of the solar field, wherein the plurality of sun rays are concentrated on the fluid circulating tube for transferring heat from the sun rays to the HTF in the tube and in-turn the heat from HTF is transferred to the salt substance, as the HTF passes through the solar towers.

According to one embodiment herein, the. HTF is passed through the plurality of storage towers for melting the salt in the plurality of spherical shells. The molten salt inside the plurality of spherical shells is configured for storing the thermal energy from heat absorbed.

According to one embodiment herein, the HTF is passed through the storage tower to absorbing the heat from the spherical shells. The HTF is adopted for absorbing the heat from the molten salt in the spherical

According to one embodiment herein, the flow of HTF through the tower is continued till the solar energy is available and the thermal energy from the molten salt is utilized even, when the solar energy is unavailable.

According to one embodiment herein, the thermal energy from the molten salt is used to operate steam turbines and generate electricity.

The various embodiments herein provide, a method for storing the thermal energy in solar thermal power plant. The method comprises steps of installing a solar field adjacent to the solar thermal power plant. A plurality of spherical shells filled with the salt is packed inside an insulated storage tower. HTF such as oil, is passed through a fluid circulating tube. The HTF is circulated to a storage tower packed with a plurality of spherical shells. The heat is transferred from the HTF to the salt material in the spherical shells. The transferred heat is absorbed from the molten salt to the HTF, when the solar energy is not available. A steam turbine is operated using the thermal energy from the HTF.

According to one embodiment herein, the HTF is passed through the solar field and is heated by the incident sun rays.

According to one embodiment herein, the HTF is then passed through the towers for inciting the salt in the spherical shells. The molten salt inside the spherical shell stores the thermal energy from the sun rays.

According to one embodiment herein, the heat transfer fluid (HTF) is passed through the storage tower again when the solar energy from sun as is not available. The HTF circulated for absorbing the heat from the spherical shells. The HTF drips down on the surface of the spherical shells and absorbs the heat.

According to one embodiment herein, the HTF is then passed through the boiler for producing steam which drives the steam turbine for generating electric power.

According to one embodiment herein, the filling of the salt material in the spherical shells are evacuated in a manner to avoid, any air pockets.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a system for improving the storage capacity of a Concentrated Solar Thermal Power (CSP) plant, according to one embodiment herein.

FIG. 2 illustrates a flowchart indicating the steps involved in a method for storing the thermal energy in solar thermal power plant, according to one embodiment herein.

Although the specific features of the embodiments herein are shown in some drawings and not in others. This is done for the convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed, description is therefore not to be taken in a limiting sense.

The various embodiments herein provide an improved method and system for storing thermal energy from the sun in a concentrated solar thermal power plant. The heat storage system for storing the thermal energy of the sun comprises a plurality of insulated storage towers configured for storing a thermal energy obtained from sun and a plurality of spherical shells filled with a salt substance. The solar towers hold the plurality of spherical shells. The system further comprises a fluid circulating tube for carrying, a Heat Transfer Fluid (HTF). The HTF is configured to carry heat generated from a solar energy between the plurality of solar towers to a heat exchanger. The salt substance is used to capture heat from the HTF.

According to one embodiment herein, the salt substance is eutectic mixture of salts with appropriate melting point.

According to one embodiment herein, the solar towers are insulated to avoid dissipation of the stored thermal energy from the spherical shells to the surroundings.

According to one embodiment herein, a plurality of voids is formed between the plurality of spherical shells. The voids allow the flow of the HTF through the tower to an outlet of the thermal power plant.

According to one embodiment herein, the spherical shells comprise a plurality of fins, where the fins are protrusions formed on an outer surface of the spherical shells. The plurality of fins assists in an effective heat transfer between the HTF and the salt substance inside the spherical shells.

According to one embodiment herein, the concentrated solar thermal power plant comprises a solar field for collecting and concentrating a plurality of sun rays. The concentrated sun rays are directed to the solar towers by a plurality of mirrors.

According to one embodiment herein, the fluid circulating tube is placed at the focusing point of the solar field, wherein the plurality of sun rays are concentrated on the fluid circulating tube for transferring; heat from the sun rays to the HTF in the tube and in-turn the heat from HTF is transferred to the salt substance, as the HTF passes through the solar towers.

According to one embodiment herein, the HTF is passed through the plurality of storage towers for melting the salt in the plurality of spherical shells. The molten salt inside the plurality of spherical shells is configured for storing the thermal energy from heat absorbed.

According to one embodiment herein, the HTF is passed through the storage tower for absorbing the heat from the spherical shells. The HTF is adopted for absorbing the heat from the molten salt in the spherical shells.

According to one embodiment herein, the flow of HTF through the tower is continued till the solar energy is available and the thermal energy from the molten salt is utilized when the solar energy is unavailable.

According to one embodiment herein, the thermal energy from the molten salt is used to operate steam turbines and generate electricity,

The various embodiments herein, provide a method for storing the thermal energy in solar thermal power plant. The method comprises steps of installing a solar field adjacent to the solar thermal power plant. A plurality of spherical shells filled with the salt is packed inside an insulated storage tower. A HTF such as oil, is passed through a fluid circulating tube. HTF is circulated to a storage tower packed with a plurality of spherical shells. The heat is transferred from the. HTF to the salt material in the spherical shells. The transferred heat is absorbed from the molten salt to the HTF, when the solar energy is not available. A steam turbine is operated using the thermal energy from the HTF.

According to one embodiment herein, the HTF is passed through the solar field and is heated by the incident sun rays.

According to one embodiment herein, the HTF is then passed through the towers for melting the salt in the spherical shells. The molten salt inside the spherical shell stores the thermal energy from the sun rays.

According to one embodiment herein, the heat transfer fluid (HTF) is passed through the storage tower again when the solar energy from sun rays is not available. The HTF circulated for absorbing the heat from the spherical shells. The HTF drips down on the surface of the spherical shells and absorbs the heat.

According to one embodiment herein, the HTF is then passed through the boiler for producing steam which drives the steam turbine for generating electric power.

According to one embodiment herein, the filling of the salt material in the spherical shells are evacuated in a manner to avoid any air pockets.

The embodiments herein provide an improved system and method for storing thermal energy from the sun in a concentrated solar thermal power plant. The heat storage system for storing the thermal energy of the sun adopts a plurality of spherical shells tilled with salt and one or more insulated storage towers. The salt is eutectic mixture of salts with appropriate melting point. In one embodiment, the salt is a eutectic mixture of sodium nitrate and potassium nitrate. The method for storing the thermal energy comprises the steps of packing a plurality of spherical shells filled with the salt inside the insulated storage tower. Based on the requirement, an appropriate number of insulated towers are constructed and filled with the spherical shells. During the day, a Heat transfer fluid arm is passed through a solar field and is heated by the incident sun rays. The HTF is then passed through the towers and used to melt the salt in the spherical shells. After sunset, the heat transfer fluid (HTF) is passed through the storage tower again but for absorbing the heat from the spherical shells. The HTF is then passed through the boiler for producing steam which drives the steam turbine, for generating electric power.

According to one embodiment herein, the heat storage system for storing thermal energy of the sun comprises a salt, a plurality of spherical shell and one or more insulated towers. The spherical shell is filled with a salt material. The filling of the salt material in the spherical shell is done in a manner to avoid any air pockets, i.e. spherical shells are evacuated. The salt tilled spherical shells are packed and sealed to avoid any contamination. The sealed spherical shells are then stacked in the vertically placed insulated towers. The insulated towers avoid a dissipation of the stored thermal energy from the spherical shells to the surroundings. The heat storage system is scalable due to the usage of individual spherical shells for storing molten salt. When the spherical shells are placed inside the tower, voids are formed between the spherical shells. The voids allow the flow of the HIT through the tower to the outlet. The spherical shells are provided with projections/protrusions on the outer surface referred to as fins. When the flows through the packed tower, the fins of the spherical shells assist in an effective heat transfer to and from the HTF.

According to one embodiment herein, a method for storing thermal energy of the sun in solar thermal power plant is provided. The method for storing the thermal energy comprises the steps of installing a solar field adjacent to an existing solar thermal power plant. The new solar field is installed only for the purpose of storing the thermal energy of the sun. The method further comprises passing a HTF such as oil, through a fluid circulating tube. The fluid circulating tube is placed at the focusing point of the solar field panels. The solar field panels concentrate the incident radiation of the sun to the fluid circulating tube and the HTF absorbs the heat. The method further comprises, circulating the HTF to a storage tower packed with a plurality of spherical shells. The pluralities of spherical shells are filled with the salt. The method further comprises transferring the heat from the HTF to the salt material in the spherical shells. The flow of HTF through the tower packing is continued till the sun sets. The salt material absorbs the heat from the HTF and changes to a molten state. The molten salt has the property of retaining the heat for long periods.

According to one embodiment herein, a method for generating power after sunset comprises the steps of forming a heat transfer loop through the tubes of the storage tower and a heat exchanger followed by pumping a HTF through the storage tower. The molten salt inside the spherical shell stores the thermal energy. The HTF drips down on the surface of the spherical shells and absorbs the heat. The method further comprises driving the HTF through the heat exchanger to convert water into steam. The steam then rotates a steam turbine and generates electric power.

According to one embodiment herein, the heat storage system provides a single, separate tower for storing the thermal energy of to the sun in the Concentrated Solar Thermal Power (CSP) Plant. Also, the heat storage system easily handles and packages the salt. The method of storing the thermal energy in the heat storage system is applicable to all solar based thermal power plants.

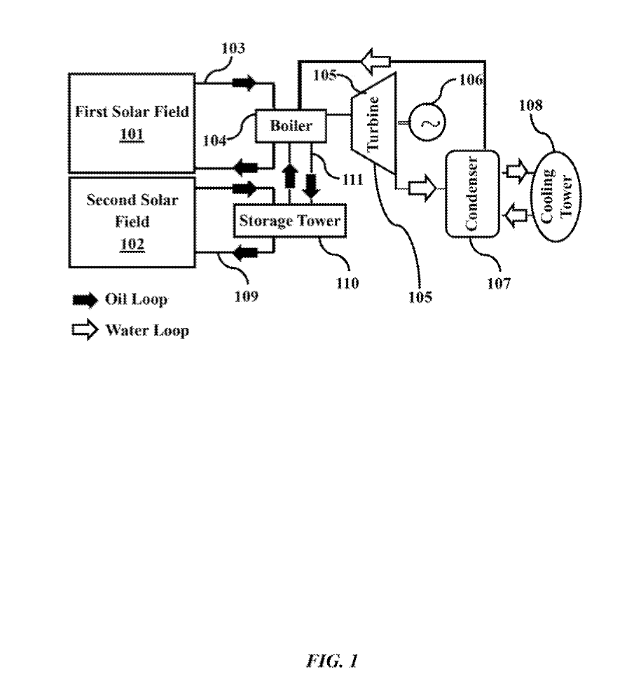

FIG. 1 illustrates a block diagram for improving the storage capacity of a Concentrated Solar Thermal Power ((TSP) plant, according to one embodiment herein. The CSP comprises a first solar field 101 and a second solar field 102 as shown in FIG. 1. The first solar field 101 is laid out in an open area for collecting and concentrating the incident sun rays. The first solar field 101 comprises a plurality of mirrors, aligned in a predetermined order. The plurality of mirrors focuses the incident sun rays towards a specific point. The plurality of mirrors is any one or a combination of parabolic troughs, Fresnel type. etc. Alternately, the pluralities of mirrors are arranged in a manner such that the incident solar rays (radiations) are directly routed to a solar tower for generating heat. The generated heat is transferred to a HTF such as Thermal VP-1 or similar oil. A circulating tube 103 is placed at the heating point of the mirrors for carrying the HTF (HTF). The HTF absorbs heat due to the concentrated radiation focused by the plurality of mirrors onto the circulating tubes 103. The HTF carries the absorbed heat out of the first solar field 101 through the fluid circulating tubes 103 to a boiler 104. The boiler 104 is a heat exchanging compartment. The heat from the HTF is transferred to a driving fluid (preferably water) inside the boiler 104. The boiler 104 converts the water into steam and is directed to a header through a pipe. The header supplies the steam to a steam turbine 105. The rotor wheel of the steam turbine 105 drives the flexible coupling which is coupled to a generator 106 for generating power. The steam flowing to the steam turbine 105 is controlled by a flow control valve. The steam after passing through the steam turbine 105 is condensed back to a liquid through a condenser 106 and is circulated back to the boiler 104. The fluid used for condensing the steam evaporates due the exchange of heat. The evaporated fluid is exhausted to the atmosphere through a cooling tower 107.

With respect to FIG. 1, the second solar field 102 is constructed in the same maimer of the first solar field 101. While the first solar field 101 is used for generating electric power, the second solar field 102 is used only for storing the thermal energy of the sun rays. The heat generated by the concentrated mirror arrangements in the second solar field 102 is transferred to the HTF. The HTF flows through a fluid circulating tube 109 placed at the heating point of the mirrors. The HTF absorbs the heat due to the concentrated radiation focused by the plurality of mirrors onto the fluid circulating tubes 109. The HTF is circulated through a storage tower 110. The storage tower 110 is stacked with the spherical shells which are in turn tilled with a salt. The salt is generally composed of material with good heat transfer and retention characteristics, for example, Potassium Nitrate and sodium nitrate etc. The salt is eutectic mixture of salts with appropriate, melting point. In one embodiment, the salt is a eutectic mixture of sodium nitrate and potassium nitrate. The spherical shell comprises a fin like projections and evacuated and sealed after being filled with the salt. The salt expands and contracts inside the spherical shells and also remains uncontaminated. When the HTF is circulated through the storage tower 1110, the salt material inside the spherical shells absorbs the heat and changes to molten state. The molten salt retains the heat for longer periods. The circulation of HTF through the storage tower 110 is continued till the sun is set for storing the maximum possible thermal energy. When the sun is set, the HTF is passed through the storage tower through a secondary loop 111. Inside the storage tower 110, the HTF drips down over the spherical shells and absorb heat from the molten salt. The molten salt transfers the absorbed heat to the HTF. The HTF is then passed through the boiler which produces steam to run the steam turbine 105. The steam turbine 105 runs the generator 106 and generates electric power.

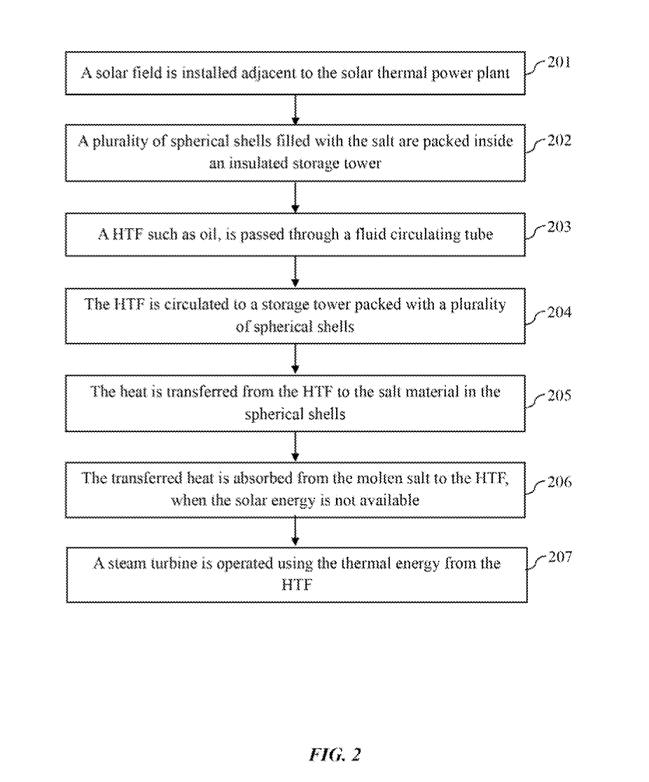

FIG. 2 illustrates a flowchart indicating the steps involved in a method for storing the thermal energy in solar thermal power plant, according to one embodiment herein. The method comprises steps of installing a solar field adjacent to the solar thermal power plant (201). A plurality of spherical shells filled with the salt is packed inside an insulated storage tower (202). A HTF such as oil, is passed through a fluid circulating tube (203). The HTF is circulated to a storage tower packed with a plurality of spherical shells (204). The heat is transferred from the HTF to the salt material in the spherical shells (205). The transferred heat is absorbed from the molten salt to the HTF, when the solar energy is not available (206). A steam turbine operating using the thermal energy from the HTF (207).

The heat storage system provides a single, separate tower for storing the thermal energy of the sun in the Concentrated Solar Thermal Power (CSP) Plant. Also, the heat storage system easily handles and packages the salt. The method of storing the thermal energy in the heat storage system is applicable to all solar based thermal power plants.

The foregoing description of the specific embodiments will, so fully reveal the general nature of the embodiments herein that others can, by applying current knowledge, readily modify and/or adapt for various applications such specific embodiments thought departing from the to generic, concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific embodiments, it will be obvious for a person skilled in the art to practice the embodiments here with modifications.

It is also to be understood that the following claims are intended to cover all of the generic and specific features of the embodiments described herein and all the statements of the scope of the embodiments which as a matter of language might be said to fail there between.

What is claimed is:

1. A system for storing thermal energy in a concentrated solar thermal power plant comprising:
a plurality of insulated storage towers configured for storing a thermal energy obtained from sun;
a plurality of spherical shells filled with a salt substance, wherein the solar towers hold the plurality of spherical shells;
a fluid circulating tube for carrying a Heat Transfer Fluid (HTF);
wherein the HTF is configured to carry heat generated from a solar energy between the plurality of solar towers to a heat exchanger, and wherein the salt substance is used to capture heat from the HTF.

2. The system according to claim 1, wherein the salt substance is eutectic mixture of salts with appropriate melting point.

3. The system according to claim 1, wherein the solar towers are insulated to avoid a dissipation of the stored thermal energy from the spherical shells to the surroundings.

4. The system according to claim 1, wherein a plurality of voids are formed between the plurality of spherical shells, and wherein the voids allow the flow of the HTF though the tower to an outlet of the thermal power plant.

5. The system according to claim 1, wherein the spherical shells comprise a plurality of fins, and wherein the fins are protrusions formed on a outer surface of the spherical shells, wherein the plurality of fins assists heat transfer between the HTF and the salt substance inside the spherical shells.

6. The system according to claim 1, wherein the concentrated solar thermal power plant comprises a solar field for collecting and concentrating a plurality of sun rays, and wherein the concentrated sun rays are directed to is the solar towers by a plurality of mirrors

7. The system according to claim 1, wherein the fluid circulating tube is placed at the focusing point of the solar field, and wherein the plurality of sun rays are concentrated on the fluid circulating tube for transferring heat from the sun rays to the HTF in the tube and in-turn the heat from HTF is transferred to the salt substance, as the HTF passes through the solar towers.

8. The system according to claim 1, wherein the HTF is passed through the plurality of storage towers for melting the salt in the plurality of spherical shells, and wherein the molten salt inside the plurality of spherical shells is configured for storing the thermal energy from heat absorbed.

9. The system according to claim 1, wherein the HTF is passed through the storage tower for absorbing the heat from the spherical shells, wherein the HTF is adopted for absorbing the heat from the molten salt in the spherical shells.

10. The system according to claim 1, wherein the flow of HTF through the tower is continued till the solar energy is available and wherein the thermal energy from the molten salt is utilized when the solar energy is unavailable.

11. The system according to claim 1, wherein the thermal energy from the molten salt is used to operate steam turbines and generate electricity.

12. A method for storing the thermal energy in solar thermal power plant comprising steps of:
installing a solar field adjacent to the solar thermal power plant;
packing a plurality of spherical shells filled with the salt inside a insulated storage tower;
passing a HTF such as oil, through a fluid circulating tube;
circulating the HTF to a storage tower packed with a plurality of spherical shells;
transferring the heat from the HTF to the salt material in the spherical shells;
absorbing the transferred heat from the molten salt to the HTF, when the solar energy is not available; and
operating a steam turbine using the thermal energy from the HTF.

13. The method according to claim 12, wherein the HTF is passed through the solar field and is heated by the incident sun rays.

14. The method according to claim 12, wherein the HTF is then passed through the towers for melting the salt in the spherical shells, and wherein the molten salt inside the spherical shell stores the thermal energy from the sun rays.

15. The method according to claim 12, wherein the heat transfer fluid (HTF) is passed through the storage tower again when the solar energy from sun rays is not available, and wherein the HTF circulated for absorbing the heat from the spherical shells, and wherein the HTF drips down on the surface of the spherical shells and absorbs the heat.

16. The method according to claim 12, wherein the HTF is then passed through the boiler for producing steam which drives the steam turbine for generating electric power.

17. The method according to claim 12, wherein the filling of the salt material in the spherical shells are evacuated in a manner to avoid any air pockets.
